(19) United States
(12) Patent Application Publication
(10) Pub. No.: US 2017/0140227 A1
(43) Pub. Date: May 18, 2017

(54) SURROUNDING ENVIRONMENT RECOGNITION DEVICE

(71) Applicant: CLARION CO., LTD., Saitama-shi, Saitama (JP)

(72) Inventors: Masayuki TAKEMURA, Tokyo (JP); Masahiro KIYOHARA, Tokyo (JP); Kota IRIE, Saitama-shi (JP); Masao SAKATA, Saitama-shi (JP); Yoshitaka UCHIDA, Saitama-shi (JP)

(73) Assignee: CLARION CO., LTD., Saitama-shi, Saitama (JP)

(21) Appl. No.: 15/322,839

(22) PCT Filed: Jun. 29, 2015
(86) PCT No.: PCT/JP2015/068618

§ 371 Date: Dec. 29, 2016

(30) Foreign Application Priority Data
Jul. 31, 2014 (JP) 2014-156165

(51) Int. Cl. G06K 9/00; B60R 1/00; G08G 1/16

(52) U.S. Cl. CPC G06K 9/00791; G08G 1/16; B60R 1/00; B60R 2300/205; B60R 2300/307; B60R 2300/607; B60R 2300/8093; B60R 2300/8033

(57) ABSTRACT

The present invention addresses the problem of providing a surrounding environment recognition device that presents to a user a sensing-enabled range that varies depending on a contamination state of a lens. The present invention is characterized by comprising: an image-capturing unit that acquires an image; an application execution unit that executes an application for recognizing an object to be recognized from the image; a lens state diagnosis unit that diagnoses the lens state of a camera on the basis of the image; a sensing range determination unit that determines a sensing-enabled range allowing the sensing of the object to be recognized with the lens state diagnosed by the lens state diagnosis unit when the application is executed, and a sensing-disabled range not enabling the sensing of the object to be recognized; and a notification control unit that notifies the sensing-enabled range of the sensing range determination unit.

### TECHNICAL FIELD

The present invention relates to a surrounding environment recognition device that recognizes a surrounding environment on the basis of an image captured by a camera.

### BACKGROUND ART

Recently, there has been a tendency for an increase in the number of applications for recognizing a surrounding environment from an image captured by a camera installed in a vehicle. Among these, there is known a technology for determining whether a camera lens normally recognizes an object when a camera is installed outside a vehicle interior (PTL 1). In the technology of PTL 1, when foreign matter adhering to a camera lens is detected and a ratio of the region exceeds a threshold value, an application for recognizing a surrounding environment is stopped and an application stop state is notified to a user. From the past, there are also known various technologies that detect an immovable region not changing against a moving background from an image obtained in a vehicle travel state and detect an object only by a region excluding the immovable region.

### CITATION LIST

### Patent Literature

PTL 1: JP 2012-38048 A

### SUMMARY OF INVENTION

### Technical Problem

However, a method of suggesting a change in recognition object recognizing range to the user is not mentioned. As in the related art, there is concern that a surrounding environment is carelessly detected when the user overestimates the application only by an operation in which the application is stopped or the object is detected only by a region excluding the immovable region in the lens stain state.

The invention is made in view of the above-described circumstances and an object thereof is to provide a surrounding environment recognition device that suggests a sensing enabled range changing in response to a lens stain state to a user.

### Solution to Problem

A surrounding environment recognition device for solving the problem is a surrounding environment recognition device that recognizes a surrounding environment on the basis of an external environment image captured by a camera, and the surrounding environment recognition device includes: an image acquisition unit that acquires the image; an application execution unit that executes an application for recognizing a recognition object from the image; a lens state diagnosis unit that diagnoses a lens state of the camera on the basis of the image; a sensing range determination unit that determines a sensing enabled range capable of sensing the recognition object and a sensing disabled range incapable of sensing the recognition object on the basis of the lens state diagnosed by the lens state diagnosis unit when the application is executed; and a notification control unit that notifies at least one of the sensing enabled range and the sensing disabled range of the sensing range determination unit.

### Advantageous Effects of Invention

According to the invention, since deterioration in performance of an image recognition application caused by a stain of a lens is notified to a user, it is possible to allow a driver to drive a vehicle while paying attention to a surrounding environment in a lens stain state without an overestimation for a camera recognition function. Further, objects, configurations, and advantages other than those described above are proved by the description of the embodiment below.

### BRIEF DESCRIPTION OF DRAWINGS

FIG. 1 is a block diagram showing an internal configuration of a surrounding environment recognition device.

FIG. 2 is a block diagram showing an internal function of a lens state diagnosis unit.

FIG. 3 is a block diagram showing an internal function of a sensing range determination unit.

FIG. 4 is a block diagram showing an internal function of an application execution unit.

FIG. 5 is a block diagram showing an internal function of a notification control unit.

FIG. 6 is a schematic diagram showing an entire configuration of an in-vehicle camera system.

FIG. 7 is a diagram showing an example of a screen displayed on an in-vehicle monitor.

FIG. 8 is a diagram showing an example of a screen displayed on the in-vehicle monitor.

FIG. 9 is a diagram showing an example of an image displayed on a front glass of a vehicle.

FIGS. 10(a) to 10(c) are diagrams showing a method of detecting a particulate deposit adhering to a lens.

FIGS. 11(a) and 11(b) are diagrams showing a method of detecting sharpness of a lens.

FIGS. 12(a) to 12(c) are diagrams showing a method of detecting a water droplet adhering to a lens.

FIGS. 13-1(a) and 13-1(b) are diagrams showing a method of determining a pedestrian sensing enabled range in response to a size of a particulate deposit.

FIGS. 13-2(a) and 13-2(b) are diagrams showing an example of an image in a pedestrian sensing enabled state and a pedestrian sensing disabled state.

FIGS. 13-3(a) and 13-3(b) are diagrams showing an example of a pedestrian sensing enabled range.

FIGS. 14-1(a) and 14-1(b) are diagrams showing a method of determining a vehicle sensing enabled range in response to a size of a particulate deposit.

FIGS. 14-2(a) and 14-2(b) are diagrams showing an example of an image in a vehicle sensing disabled state and a vehicle sensing enabled state.

FIGS. 15(a) and 15(b) are diagrams showing a method of determining a barrier sensing enabled range in response to a size of a particulate deposit.

FIG. 16 is a diagram showing a definition for a durable shielding ratio and a standard size of a recognition object of each application.

FIGS. 17(a) and 17(b) are diagrams showing a method of determining a sensing enabled range in response to sharpness.

FIGS. 18(a) and 18(b) are diagrams showing a definition for a maximal detection distance set in response to sharpness of each application.

FIGS. 19(a) and 19(b) are diagrams showing a method of determining a sensing enabled range in response to a size of a water droplet.

FIGS. 20(a) and 20(b) are diagrams showing a definition for a maximal detection distance and a limited water droplet occupying ratio set in response to a water droplet adhering state in each application.

FIG. 21 is a diagram comparing a sensing enabled range in response to a recognition object.

### DESCRIPTION OF EMBODIMENTS

Next, an embodiment of a surrounding environment recognition device of the invention will be described below with reference to the drawings. Further, in the embodiment below, an example will be described in which the surrounding environment recognition device of the invention is applied to an in-vehicle environment recognition device mounted on a vehicle such as an automobile, but the invention is not limited to the in-vehicle environment recognition device. For example, the surrounding environment recognition device can be also applied to a construction machine, a robot, a monitoring camera, an agricultural machine, and the like.

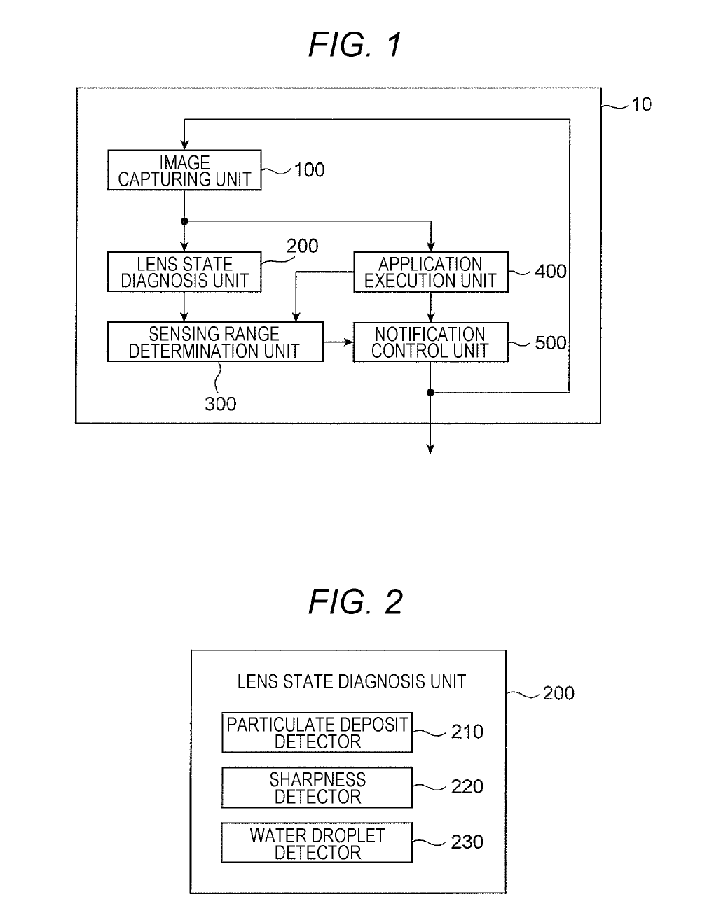

FIG. 1 is a block diagram showing an internal function of the surrounding environment recognition device.

An in-vehicle surrounding environment recognition device 10 of the embodiment is used to recognize a surrounding environment of a vehicle on the basis of an image obtained by capturing an external environment by an in-vehicle camera. The surrounding environment recognition device 10 includes an in-vehicle camera which captures an outside image of the vehicle and a recognition device which recognizes a surrounding environment on the basis of an image captured by the in-vehicle camera. However, the in-vehicle camera is not essentially necessary for the surrounding environment recognition device as long as only an outside image captured by the in-vehicle camera or the like can be acquired.

The surrounding environment recognition device 10 includes, as illustrated in FIG. 1, an image capturing unit 100, a lens state diagnosis unit 200, a sensing range determination unit 300, an application execution unit 400, and a notification control unit 500.

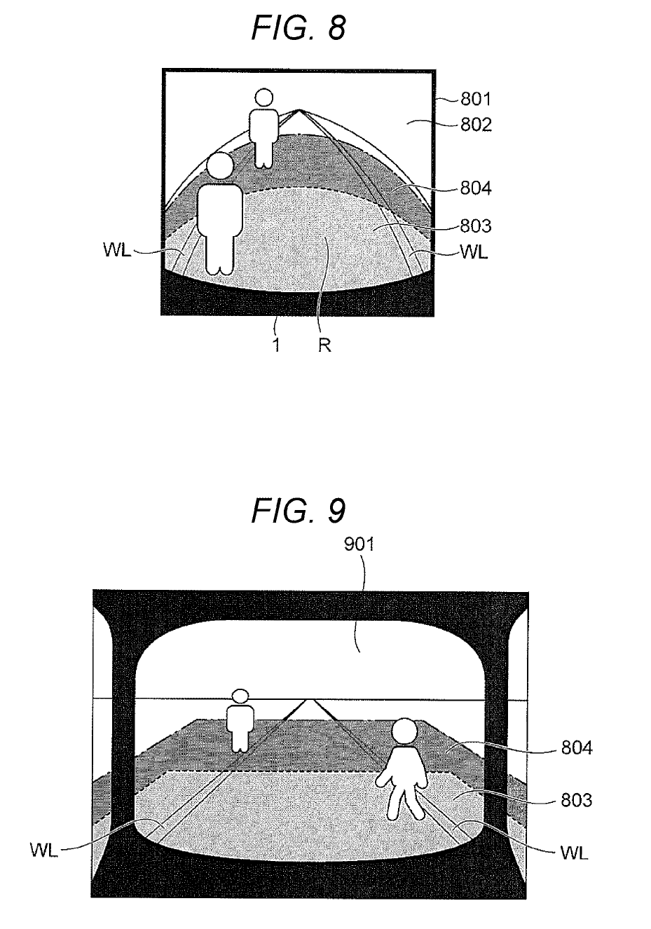

The image capturing unit 100 captures a vehicle surrounding image acquired by, for example, in-vehicle cameras 101 (see FIG. 6) attached to front, rear, left, and right sides of a vehicle body (an image acquisition unit). The application execution unit 400 recognizes an object from the image acquired by the image capturing unit 100 and executes various applications for detecting a pedestrian or a vehicle (hereinafter, referred to as an application).

The lens state diagnosis unit 200 diagnoses a lens state of each in-vehicle camera 101 on the basis of the image acquired by the image capturing unit 100. The in-vehicle camera 101 includes an imaging element such as a CMOS and a lens of an optical system disposed at the front side of the imaging element. Further, the lens of the embodiment is not limited to a focus adjusting lens and generally also includes a glass of an optical system (for example, a stain preventing filter lens or a polarizing lens) disposed at the front side of the imaging element.

The lens state diagnosis unit 200 diagnoses a stain caused by a particulate deposit, cloudness, or a water droplet of the lens. When the in-vehicle camera 101 is disposed, for example, outside the vehicle, there is concern that a particulate deposit of mud, trash, or bugs may adhere to the lens or the lens may become cloudy like obscure glass due to dust or a water stain. Further, there is concern that the water droplet adheres to the lens so that the lens becomes dirty. When the lens of the in-vehicle camera 101 becomes dirty, a part or the entirety of a background captured in an image is hidden or a background image becomes dim due to low sharpness or becomes distorted. As a result, there is concern that the object may not be easily recognized.

The sensing range determination unit 300 determines a sensing enabled range capable of recognizing a recognition object on the basis of the lens state diagnosed by the lens state diagnosis unit 200. The sensing enabled range changes in response to a stain degree including a particulate deposit adhering position and a particulate deposit size with respect to the lens. Also, the sensing enabled range also changes in response to the application executed by application execution unit 400. For example, even when the lens stain degree and the distance from the lens to the object are the same, the sensing enabled range becomes wider when the recognition object of the application is a large object such as a vehicle compared to a small object such as a pedestrian.

The notification control unit 500 executes a control that notifies at least one of the sensing enabled range and the sensing disabled range to a user on the basis of information from the sensing range determination unit 300. The notification control unit 500 notifies a change in sensing enabled range to the user, for example, in such a manner that the sensing enabled range is displayed or a warning sound or a message is generated for the user by the use of an in-vehicle monitor or a warning device. In this way, the information can be provided for the vehicle control device in response to the sensing enabled range so that the vehicle control device can use the information for a vehicle control.

FIG. 6 is a schematic diagram showing an example of a system configuration of the vehicle and an entire configuration of the in-vehicle camera system. The surrounding environment recognition device 10 has an internal configuration of the image processing device 2 that executes an image process of the in-vehicle camera 101 and an internal function of the vehicle control device 3 that executes a vehicle control or a notification to a driver on the basis of a process result transmitted from the image processing device. The image processing device 2 includes, for example, the lens state diagnosis unit 200, the sensing range determination unit 300, and the application execution unit 400 and the vehicle control device 3 includes the notification control unit 500.

The vehicle 1 includes a plurality of in-vehicle cameras 101, for example, four in-vehicle cameras 101 including a front camera 101a capturing a front image of the vehicle 1, a rear camera 101b capturing a rear image thereof, a left camera 101c capturing a left image thereof, and a right camera 101d capturing a right image thereof. Accordingly, the peripheral image of the vehicle 1 can be continuously captured. In addition, the in-vehicle camera 101 may not be provided at a plurality of positions, but may be provided at one position. Further, only the front or rear image maybe captured instead of the peripheral image.

The left and right in-vehicle cameras 101 may be configured as cameras attached to side mirrors or cameras installed instead of the side mirrors. The notification control unit 500 is a user interface and is mounted on hardware different from the image processing device 2. The notification control unit 500 executes a control that realizes a preventive safety function or a convenience function by the use of a result obtained by the application execution unit 400.

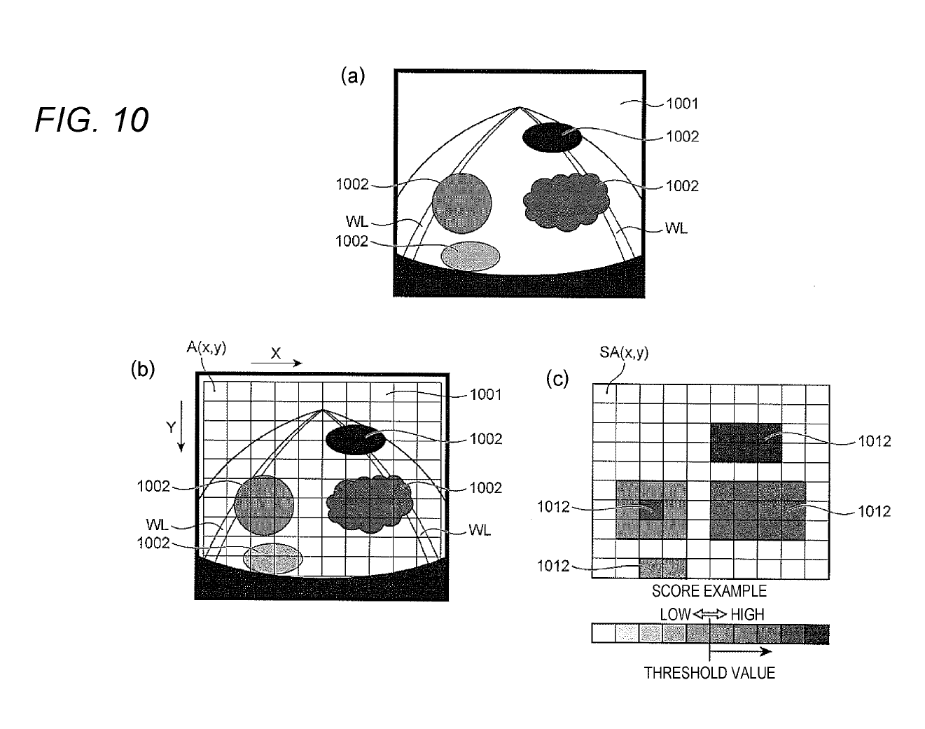

FIG. 7 is a diagram showing an example of a screen displayed on the in-vehicle monitor.

From the past, there is known an overview display method of suggesting a sensing enabled range of an application obtained when a predetermined application is executed during a normal operation of the system while a distance space is viewed from the upside of an own vehicle (the vehicle 1) to the in-vehicle monitor 700.

A minimum sensing line 701 in which an object closest to the vehicle 1 can be sensed (recognized) by a predetermined application is indicated by a small oval surrounding the periphery of the vehicle 1 and a maximum sensing line 702 in which an object farthest from the vehicle 1 can be sensed (recognized) by the same application is indicated by a large oval. When a space between the minimum sensing line 701 and the maximum sensing line 702 becomes a sensing range 704 and the lens is in a normal state without a stain, the entire sensing range 704 becomes the sensing enabled range. In addition, a reference numeral 703 indicated by the dashed line in the drawing indicates a part in which the image capturing ranges of the adjacent in-vehicle cameras overlap each other.

The sensing range 704 is set in response to the application in execution. For example, when the object of the application is relatively large like the vehicle 1, the maximum sensing line 702 and the minimum sensing line 701 respectively increase in size. Further, when the object is relatively small like a pedestrian or the like, the maximum sensing line 702 and the minimum sensing line 701 respectively decrease in size.

When a stain or the like exists on the lens of the in-vehicle camera 101, it is difficult to detect a recognition object in a background part hidden by the stain or the like even within the sensing range 704. As a result, there is concern for a performance deterioration state in which the application cannot exhibit predetermined performance. In the surrounding environment recognition device of the invention, a control of notifying the performance deterioration state of the application to the user is executed.

As a notification method, for example, a method can be employed in which the sensing enabled range and the sensing disabled range of the sensing range 704 are visually displayed on the in-vehicle monitor or the like so that the performance deterioration state is accurately notified to the user. In this display method, a detectable distance from the vehicle 1 can be easily checked and a sensing ability deterioration degree caused by deterioration in performance can be easily suggested to the user. Further, the performance deterioration state of the application may be notified to the user in such a manner that an LED provided on a meter panel or the like inside a vehicle interior is turned on or a warning sound or a vibration is generated.

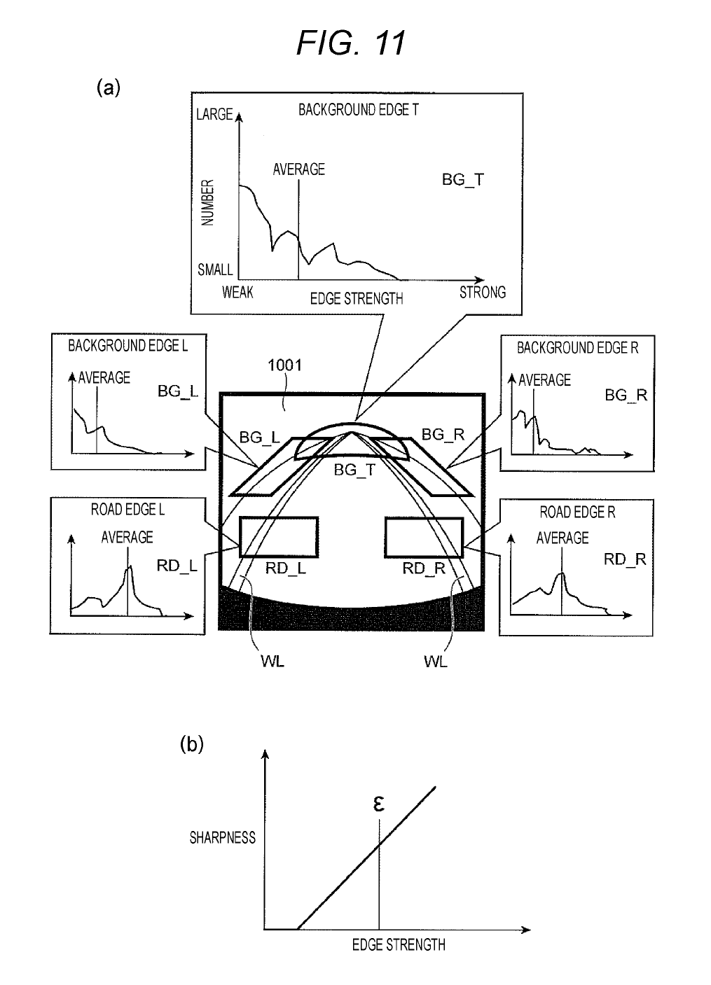

FIG. 8 is a diagram showing an example of a screen displayed on the in-vehicle monitor. An in-vehicle monitor 801 displays an image 802 captured by the in-vehicle camera 101 installed at the front part of the vehicle and also displays a sensing enabled region 803 and a sensing disabled region 804 to be displayed to overlap the image 802. The image 802 includes a road R at the front side of the vehicle 1 and left and right white lines WL indicating a travel vehicle lane. By such a display, the sensing enabled region 803 set in response to the lens state can be notified to the driver while the lens state of the in-vehicle camera 101 (see FIG. 6) is viewed. Then, since the sensing enabled region 803 and the lens state indicating, for example, a message that “wiping is necessary since a far place is not visible in such a stain degree” are viewed simultaneously, the sensing ability of the in-vehicle camera 101 can be easily notified to the driver.

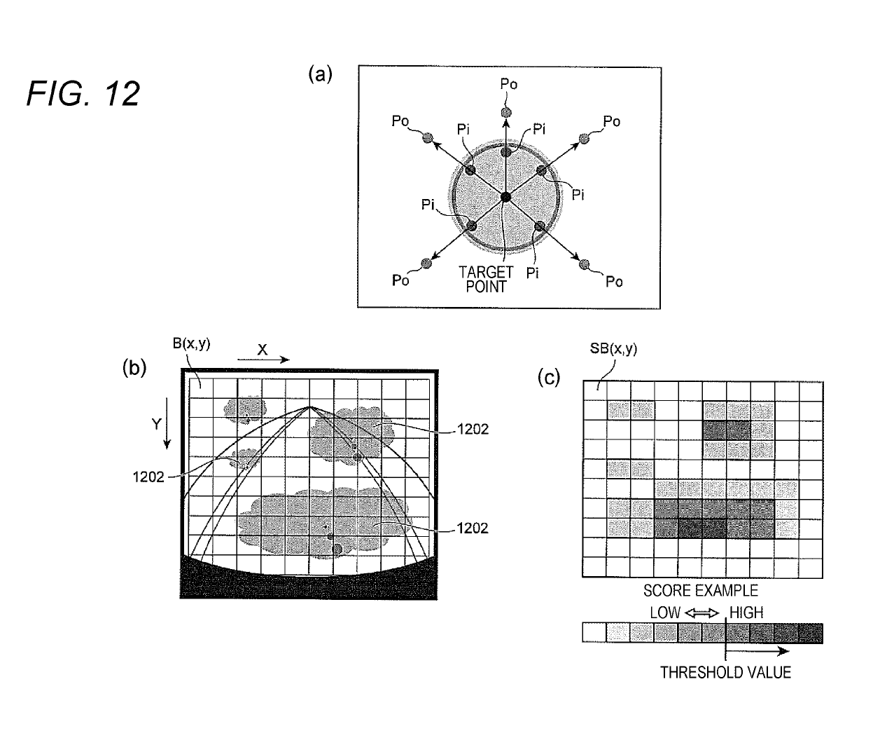

FIG. 9 is a diagram showing an example of an image displayed on a front glass of the vehicle.

Here, a scene which is viewed from the vehicle interior through a front glass 901 by the use of a head up display (HUD) overlaps a real world. Since the sensing enabled region 803 or the sensing disabled region 804 are viewed while overlapping a road of the real world, the sensing enabled region or the sensing distance of the actual in-vehicle camera 101 can be easily and visually checked. Here, since a projection type head up display for the front glass 901 shields a driver's view, a display on the entire face of the front glass 901 is difficult. For this reason, as illustrated in FIG. 9 the overlap display with the road using the lower side of the front glass 901 may be performed in such a manner that the sensing enabled region 803 is suggested to overlap the real world by the use of the overlap display at the upper side of the front glass 901.

Next, the execution content of the lens state diagnosis unit 200, the sensing range determination unit 300, the application execution unit 400, and the notification control unit 500 illustrated in FIG. 1 will be described sequentially.

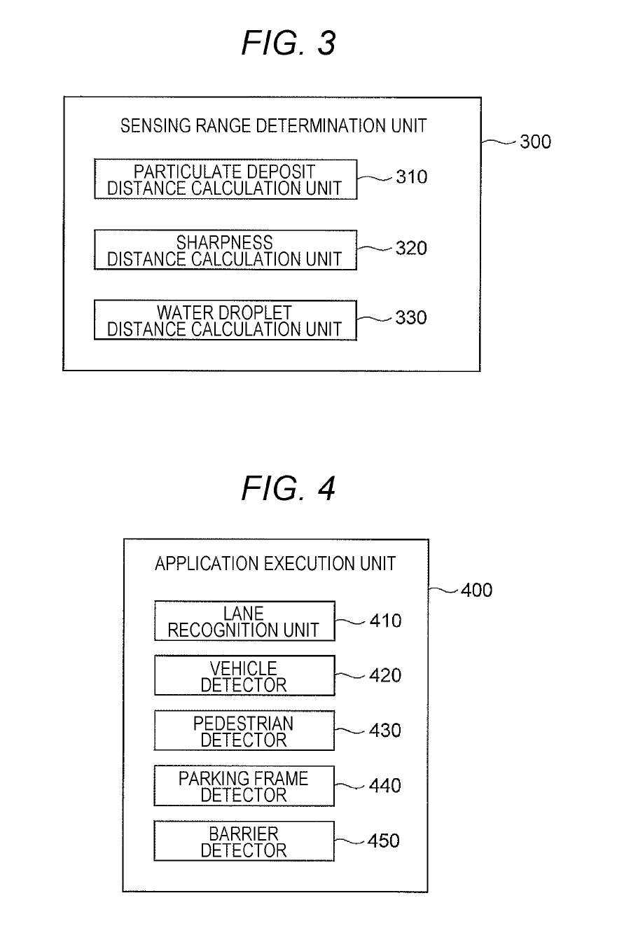

FIG. 2 is a block diagram showing an internal function of the lens state diagnosis unit 200. The lens state diagnosis unit 200 includes a particulate deposit detector 210, a sharpness detector 220, and a water droplet detector 230 and diagnoses a stain state in accordance with the type of stain adhering to the lens of the in-vehicle camera 101 on the basis of the image acquired by the image capturing unit 100.

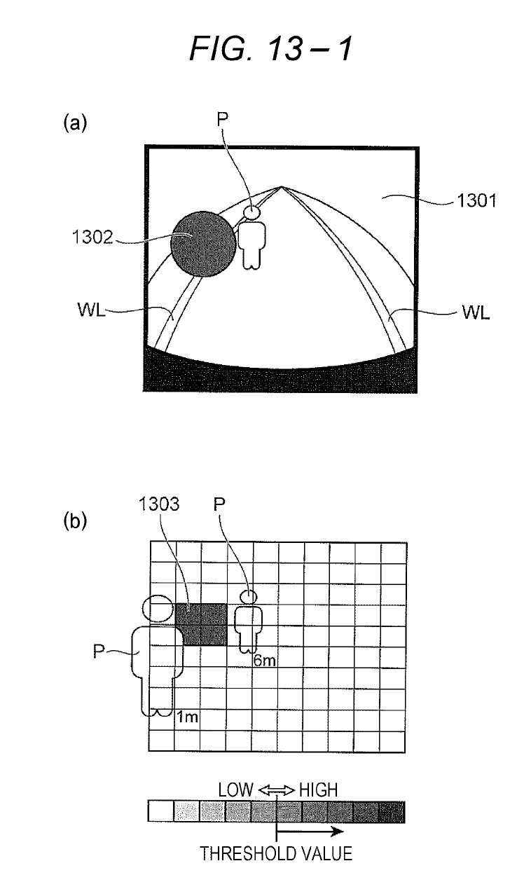

FIGS. 10(a) to 10(c) are diagrams showing a method of detecting a particulate deposit adhering to the lens. Here, FIG. 10(a) shows an image 1001 at the front side of the in-vehicle camera 101 and FIGS. 10(b) and 10(c) show a method of detecting the particulate deposit.

As illustrated in FIG. 10(a), the image 1001 is dirty since a plurality of particulate deposits 1002 adhere to the lens. The particulate deposit detector 210 detects the particulate deposit adhering to the lens, for example, the particulate deposit 1002 such as mud shielding the appearance of the background. When the particulate deposit 1002 such as mud adheres to the lens, the background is not easily visible and the brightness is continuously low compared to the periphery. Thus, it is possible to detect the particulate deposit 1002 by detecting a region having a small brightness change amount.

First, the particulate deposit detector 210 divides an image region of the image 1001 into a plurality of blocks A (x, y) as illustrated in FIG. 10(b). Next, the brightness values of the pixels of the image 1001 are detected and a total sum Iₜ (x, y) of the brightness values of the pixels included in the block A (x, y) is calculated for each block A (x, y). Then, a difference ΔI (x, y) between the total sum Iₜ (x, y) calculated for a captured image of a current frame and a total sum Iₜ₋₁ (x, y) calculated for a captured image of a previous frame is calculated for each block A (x, y). Then, the block A (x, y) in which the difference ΔI (x, v) is smaller than those of the peripheral blocks is detected and a score SA (x, y) corresponding to the block A (x, y) is increased by a predetermined value, for example, “1”.

The particulate deposit detector 210 calculates an elapse time tA from the initialization of the score SA (x, y) of each block A (x, y) after the above-described determination for all pixels of the image 1001. Then, a time average SA (x, y)/tA of the score SA (x, y) is calculated in such a manner that the score SA (x, y) of each block A (x, y) is divided by the elapse time tA. The particulate deposit detector 210 calculates a total sum of the time average SA (x, y)/tA of all blocks A (x, y) and divides the total sum by the number of all blocks of the captured image to calculate a score average SA_ave.

When a stain 1002 such as mud continuously adheres to the lens of the in-vehicle camera 101, the score average SA_ave increases in each of the sequentially captured frames. In other words, when the score average SA_ave is large, there is a high possibility that mud or the like adheres to the lens for a long period of time. It is determined whether the time average SA (x, y)/tA exceeds a predetermined threshold value. Here, a region in which the time average exceeds the threshold value is determined as a region (a particulate deposit region) in which a background is not visible due to mud. This region is used to calculate the sensing enabled range of each application in response to the size of the region in which the time average exceeds the threshold value. Further, a final determination is made for the operation of each application by the use of the score average SA_ave. FIG. 10(c) shows a score example in which all blocks are depicted as color gradation depending on the score. Then, when the score is equal to or larger than a predetermined threshold value, a region 1012 is determined in which the background is not visible due to the particulate deposit.

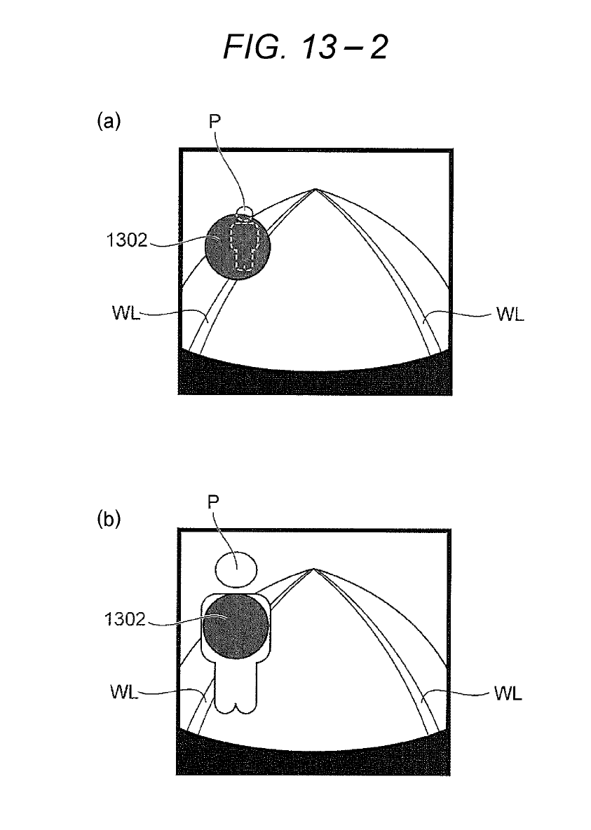

Next, an operation of the sharpness detector 220 will be described with reference to FIGS. 11(a) and 11(b). FIGS. 11(a) and 11(b) are diagrams showing a method of detecting the sharpness of the lens. The sharpness detector 220 detects the lens state on the basis of a sharpness index representing whether the lens is clear or unclear. A state where the lens is not clear indicates, for example, a state where a lens surface becomes cloudy due to the stain and a contrast becomes low. Accordingly, an outline of an object is dimmed and the degree is indicated by the sharpness.

As illustrated in FIG. 11(a), the sharpness detector 220 sets a left upper detection region BG_L (Background Left), an upper detection region BG_T (Background Top), and a right upper detection region BG_R (Background Right) at a position where a horizontal line is reflected on the image 1001. The upper detection region BG_T is set to a position including a horizontal line and a vanishing point where two lane marks WL are provided in parallel on the road intersect each other at a far position. The left upper detection region BG_L is set to the left side of the upper detection region BG_T and the right upper detection region BG_R is set to the right side of the upper detection region BG_T. The regions including the horizontal line are set so that edges are essentially included on the image. Further, the sharpness detector sets a left lower detection region RD_L (Road Left) and a right lower detection region RD_R (Road Right) at a position where the lane mark WL is reflected on the image 1001.

The sharpness detector 220 executes an edge detection process on pixels within each region of the left upper detection region BG_L, the upper detection region BG_T, the right upper detection region BG_R, the left lower detection region RD_L, and the right lower detection region RD_R. In the edge detection for the left upper detection region BG_L, the upper detection region BG_T, and the right upper detection region BG_R, an edge such as a horizontal line is essentially detected. Further, in the edge detection for the left lower detection region RD_L and the right lower detection region RD_R, the edge of the lane mark WL or the like is detected.

The sharpness detector 220 calculates an edge strength value for each pixel included in the detection regions BG_L, BG_T, BG_R, RD_L, and RD_R. Then, the sharpness detector 220 calculates an average value Blave of the edge strength values of each of the detection regions BG_L, BG_T, BG_R, RD_L, and RD_R and determines a sharpness degree on the basis of the average value Blave. As illustrated in FIG. 11(b), the sharpness is set so that the lens is clear as the edge strength becomes strong and the lens nclear as the edge strength becomes weak.

It is determined that the application recognition performance is influenced when the calculated average value Blave is lower than standard sharpness. Then, the application performance deterioration degree is determined for each application by the use of the sharpness average value for each region. When the sharpness is lower than minimal sharpness α2, it is determined that the recognition in each application is difficult.

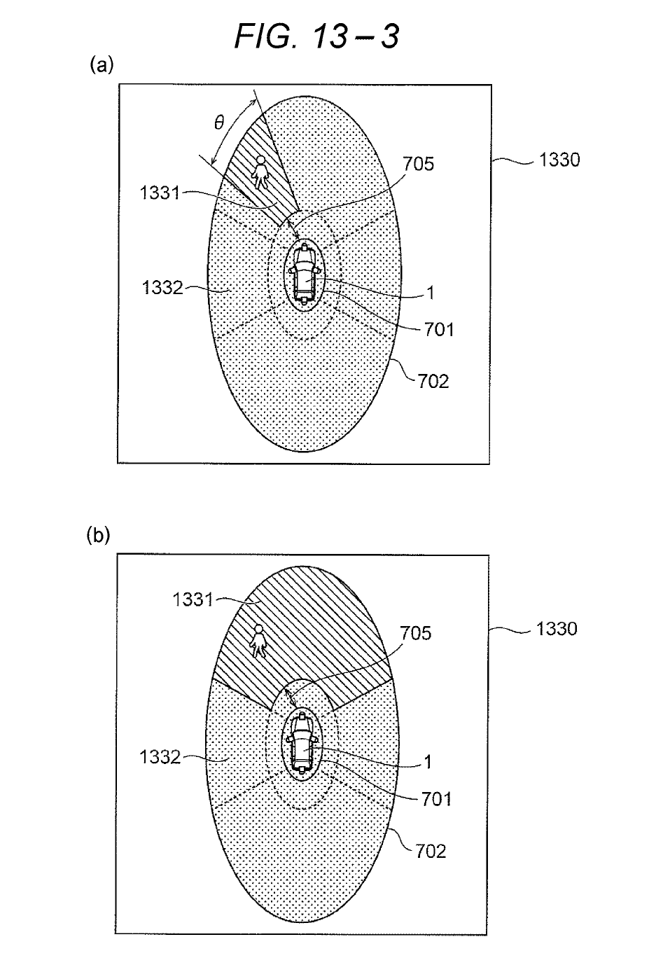

FIGS. 12(a) to 12(c) are diagrams showing a method of detecting a water droplet adhering to the lens.

The water droplet detector 230 of FIG. 2 extracts a water droplet feature amount by comparing the brightness of the peripheral pixels on an imaging screen illustrated in FIG. 12(a). The water droplet detector 230 sets pixels which are separated from an interest point by a predetermined distance (for example, three pixels) in the up direction, the right up direction, the right down direction, the left up direction, and the left down direction as inner reference points Pi and sets pixels which are further separated therefrom by a predetermined distance (for example, pixels more than three pixels) in the five directions as outer reference points Po. Next, the water droplet detector 230 compares the brightness for each inner reference point Pi and each outer reference point Po.

There is a high possibility that the vicinity of the inside of the edge of the water droplet 1202 is brighter than the outside due to a lens effect. Here, the water droplet detector 230 determines whether the brightness of the inner reference point Pi at the inside of the edge of the water droplet 1202 is higher than the brightness of the outer reference point Po in each of five directions. In other words, the water droplet detector 230 determines whether the interest point is at the center of the water droplet 1202. When the brightness of the inner reference point Pi in each direction is higher than the brightness of the outer reference point Po in the same direction, the water droplet detector 230 increases a score SB (x, y) of a region B (x, y) included in the interest point in FIG. 12(b) by a predetermined value, for example, “1”. As for the score of B (x, y), an instantaneous value at a predetermined time tB is stored and a past score stored for the time tB or more is discarded.

The water droplet detector 230 executes the above-described determination for all pixels in a captured image. Then, the water droplet detector obtains a total sum of the score SB (x, y) of each block B (x, y) for an elapse time tB, calculates a time average score SB (x, y) by dividing the total sum by the time Tb, and calculates a score average SB_ave by dividing the time average score by the number of all blocks in the captured image. A degree in which the score SB (x, y) of each divided region exceeds a specific threshold value ThrB is determined as a score. Then, the divided region exceeding the threshold value and the score are depicted on a map as illustrated in FIG. 12(c) and a sum SB2 of the scores on the map is calculated.

When the water droplet continuously adheres to the lens of the in-vehicle camera 101, the score average SB_ave for each frame increases. In other words, when the score average SB_ave is large, there is a high possibility that the water droplet adheres to the lens position. The water droplet detector 230 determines whether many water droplets adhere to the lens by the use of the score average SB_ave. The sum SB2 is appropriate when the water droplet adhering amount on the lens is large and a failure determination on the entire system is made by the use of this value. In the determination of each logic, a separate water droplet occupying ratio is used to determine a maximal detection distance.

Both the water droplet adhering amount and the score average SB_ave are used in the determination for deterioration in performance of the recognition application due to the stain of the lens. The a method of calculating the sensing enabled range is considered. FIG. 12(c) shows a score example in which all blocks are depicted as color gradation depending on the score. Then, when the score is equal to or larger than a predetermined threshold value, a region in which a background is not visible due to the water droplet is determined.

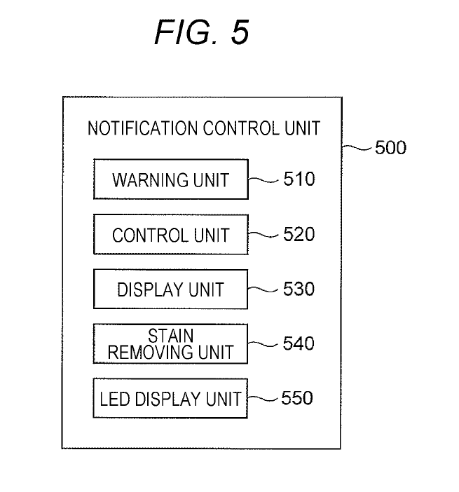

FIG. 3 is a diagram showing an internal function of the sensing range determination unit. The sensing range determination unit 300 includes a particulate deposit distance calculation unit 310, a sharpness distance calculation unit 320, and a water droplet distance calculation unit 330 and executes a process of determining the sensing enabled range by the use of a diagnosis result of the lens state diagnosis unit 200. In the particulate deposit distance calculation unit 310, a sensing enabled range capable of guaranteeing the detection of each application by the use of the detection result of the particulate deposit detector 210 is converted. In the sharpness distance calculation unit 320, a sensing enabled range capable of guaranteeing the detection of each application by the use of the detection result of the sharpness detector 220 is converted. In the water droplet distance calculation unit 330, a sensing enabled range capable of guaranteeing the detection of each application by the use of the detection result of the water droplet detector 230 is converted.

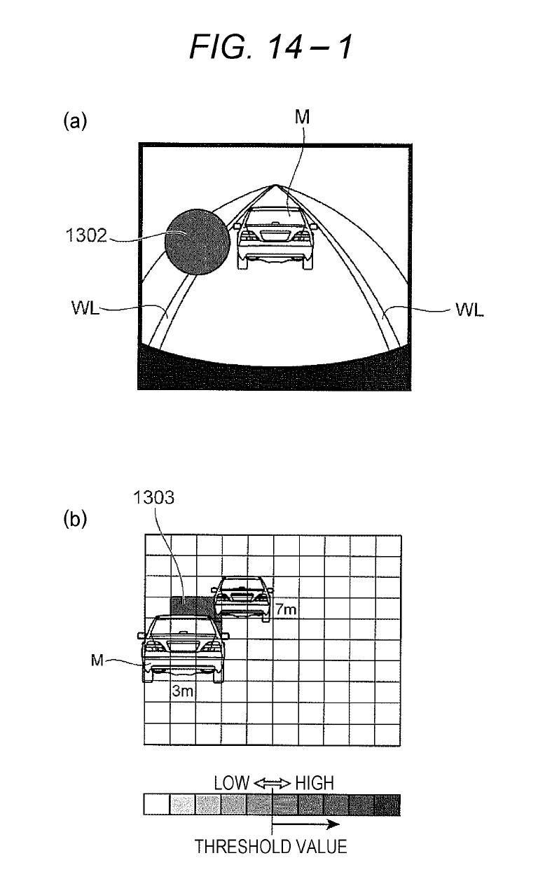

The particulate deposit distance calculation unit 310 calculates the sensing enabled range in response to the detection result of the particulate deposit detector 210. It is determined whether the time average SA (x, y)/tA exceeds a predetermined threshold value by the use of the result of the particulate deposit detector 210. Then, a region exceeding the threshold value is determined as a region in which a background is not visible due to mud. For example, as illustrated in FIG. 13-1(a), when a particulate deposit 1302 such as mud adheres to a left upper side of an image 1301, it is determined that the time average SA (x, y)/tA corresponding to the region of the particulate deposit 1302 exceeds a predetermined threshold value. Accordingly, as indicated by a dark region 1303 in FIG. 13-1(b), a region in which a background is not visible due to the particulate deposit 1302 is selected on the image.

Next, the sensing enabled range in this case is defined for each application. An important point herein is that the size of the recognition object in each application is different. First, an example for a pedestrian detection application will be described.

<Pedestrian Detection>

As illustrated in FIGS. 13-2(a) and 13-2(b), a pedestrian P overlaps a region in which a background is not visible due to the particulate deposit 1302. On the image, the size of the pedestrian P becomes different in response to a distance in the depth direction. Since a percentage (a ratio) in which the particulate deposit 1302 shields the pedestrian P increases as the pedestrian P is located at a far position, it is difficult to guarantee a detection at a far position and a detection in the left direction of the front fish-eye camera. In the example illustrated in FIG. 13-2(a), a pedestrian is separated from an own vehicle by 6.0 m and most part of the Pedestrian is hidden by the shade of the particulate deposit 1302 so that only a shape smaller than 40% of the size of the pedestrian is visible. For this reason, the pedestrian detector 430 of the application execution unit 400 cannot recognize the pedestrian (an unrecognizable state). Meanwhile, as illustrated in FIG. 13-2(b) when the pedestrian is separated from the own vehicle by 1.0 m, a shape equal to or larger than 40% of the size of the pedestrian is visible. For this reason, the pedestrian detector 430 can recognize the pedestrian (a recognizable state). This process is executed for each depth distance Z.

As the pedestrian, a pedestrian having a body shape (a standard size) with a height of 1.8 m is supposed. Then, the size of the pedestrian P on the image 1301 in appearance is calculated for each depth distance Z from 1 m to 5 m. Here, a maximal percentage of the pedestrian P hidden by the particulate deposit 1302 (a ratio in which a recognition object having a standard size is hidden by a particulate deposit region) is calculated by the comparison of the shape of the pedestrian P in each depth and a region part (a particulate deposit region) in which a background ot visible due to the particulate deposit 1302 such as mud. For example, a depth in which 30% or more of the pedestrian P is not visible to maximal and a viewing angle θ from the camera 101 are calculated.

FIGS. 13-3(a) and 13-3(b) illustrated examples in which a sensing disabled range 1331 incapable of recongnizing (sensing) the pedestrian and a sensing enabled range 1332 capable of recognizing (sensing) the pedestrian are displayed on a display unit 1330 such as an in-vehicle monitor. The sensing range determination unit 300 determines the sensing enabled range capable of sensing the pedestrian and the sensing disabled range incapable of sensing the pedestrian by the lens state diagnosed by the lens state diagnosis unit 200 when the application is executed.

In the example illustrated in FIG. 13-3(a), the sensing disabled range 1331 is set such that the pedestrian farther than a predetermined distance 705 is not visible in response to the shape or the size of the particulate deposit. The predetermined distance 705 is set such that a position moves close to the vehicle 1 as the size of the particulate deposit becomes large and a position moves away from the vehicle 1 as the size of the particulate deposit becomes small. An angle θ determining the horizontal width of the sensing disabled range 1331 is set in response to the size of the particulate deposit. Then, in the example of FIG. 13-3(b),particulate deposit adheres to the in-vehicle camera 101a attached to the front part of the vehicle 1. Here, since there is a high possibility that a far position is not visible due to the influence of the particulate deposit, a position farther than the predetermined distance 705 of the image captured by the in-vehicle camera 101 installed at the front part of the vehicle cannot be used.

<Vehicle Detection>

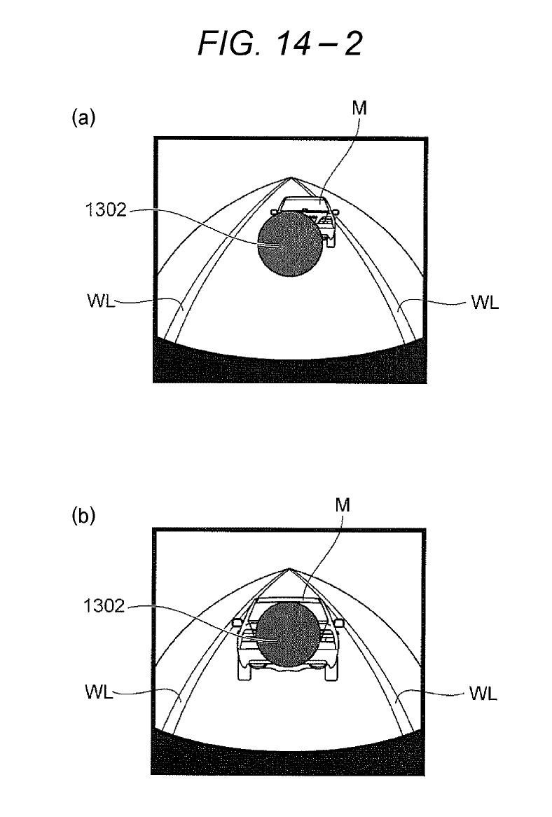

A concept of a vehicle detection is similar to that of the pedestrian detection and a vehicle M corresponding to a recognition object has a width of 1.8 m and a depth of 4.7 m. Then, a difference from the pedestrian P is that a direction of the vehicle M corresponding to the detection object is the same as a direction in which a lane is recognized or an own vehicle travels. A calculation is made on the assumption that the vehicle is a preceding vehicle or a preceding vehicle traveling on an adjacent vehicle lane in the same direction. For example, as illustrated in FIG. 14-1(a), a case in which a preceding vehicle M traveling on a lane WL overlaps the left upper particulate deposit 1302 will be examined in each depth. Since the vehicle N is larger than the pedestrian P, it is possible to detect a position farther than the pedestrian P. Here, when 40% or more of the vehicle body is hidden, it is determined that the detection is not easily guaranteed. Since the vehicle M is a rigid body compared to the pedestrian P and an artificial object, it is possible to guarantee the detection even when the hidden percentage (ratio) increases compared to the pedestrian P. For example, as illustrated in FIGS. 14-2(a) and 14-2(b), since the percentage in which the particulate deposit 1302 shields the vehicle M increases as the vehicle M is located at a far position, it is difficult to guarantee a detection at a far position and a detection in the front direction of the front fish-eye camera. In the example illustrated in FIG. 14-2(a), since the preceding vehicle is separated from the own vehicle by 7.0 m, a vehicle detector 420 cannot recognize the vehicle (an unrecognizable state). Further, in the example illustrated in FIG. 14-2(b), since the preceding vehicle is separated from the own vehicle by 3.0 m, the vehicle detector 420 can recognize the vehicle (a recognizable state).

<Lane Recognition>

A basic concept of a lane recognition is similar to that of the pedestrian detection or the vehicle detection. A difference is that a size of the recognition object is not set. However, it is important that, since the lane WL is recognized from a far position of 10 m to the vicinity of 50 cm, an invisible range from a certain meter position to a certain meter position is detected. Then, it is determined whether a stain region on a screen is hidden in a certain range on the road by the use of the geometry of the camera.

In the case of a white line (the lane WL), the right recognition performance using parallelism is influenced when a far left side is not visible. For this reason, when it is determined that a left position farther than 5 m is not visible, it is determined that a far right side of the white line cannot be recognized due to the same performance. Even in an actual image process, an erroneous detection may be reduced by an image process excluding a position farther than 5 m. Alternatively, only the stain region maybe excluded from the sensing region. While a detection guarantee range is suggested, it is determined whether the detection guarantee range can be used for a control, can be used for a warning instead of a control, or cannot be used for any purpose in consideration of the accuracy of the horizontal position, the yaw angle, and the curvature of the lane recognition deteriorating as a detection guarantee region becomes narrow.

<Parking Frame Detection>

A parking frame exists on the road as in the white line, but an approximate size of an object can be regarded as a given size differently from the white line. Of course, there is a slight difference in the size of the parking frame depending on a place. However, for example, a parking frame having a width of 2.2 m and a depth of 5 m is defined and the possibility of the hidden percentage inside the frame of the region is calculated. In fact, since only a frame line is important, the parking frame can be detected even when only the inside of the frame becomes dirty due to mud. However, when the parking frame is not visible due to the movement of the vehicle, the performance of the application cannot be guaranteed. Thus, the possibility of the hidden percentage inside the frame due to mud is calculated. When the percentage exceeds 30%, an operation cannot be guaranteed. This calculation is also executed for each depth. Further, the application using the parking frame is used for a parking assist in many cases while the vehicle is turned. For this reason, even when 30% or more of mud adheres to a position farther than 7 m at the left side of the front camera in the depth direction, a range capable of guaranteeing the application is defined as the vicinity within 7 m in the front camera.

<Barrier Detection>

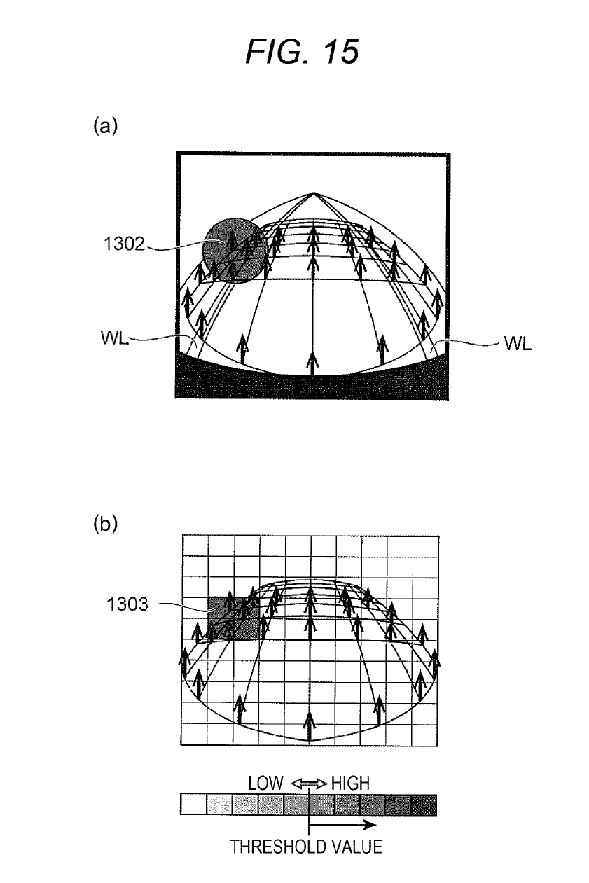

In a barrier detection, all three-dimensional objects existing around the vehicle are defined as detection objects and thus the size of the detection object cannot be defined. For this reason, in the barrier detection, a case in which a foot of a three-dimensional object existing on the road cannot be specified is defined as a case in which the barrier detection performance cannot be guaranteed. For this reason, a basic concept is supposed on the assumption that a road region having a certain size is reflected on a mud detection region. Then, an invisible distance due to a shielding ratio increasing at a certain range from the own vehicle is obtained by conversion and thus the barrier detection performance guarantee range is determined. For example, as illustrated in FIG. 15(a), when the particulate deposit 1302 adheres to the lens so that a region in which an arrow in the up direction is not visible exist, this region can be determined as a region in which a background is not visible due to the particulate deposit, that is, a sensing disabled range 1303 can be determined as illustrated in FIG. 15(b).

In this way, in the vehicle detection or the pedestrian detection capable of assuming the approximate three-dimensional size of the detection object corresponding to the three-dimensional object, the three-dimensional object having a certain size and corresponding to the detection object is assumed and a percentage in which the three-dimensional object is shielded by a certain degree of a stain on the image is calculated when the three-dimensional position is changed in the depth direction on the road and the horizontal direction perpendicular thereto. Here, an unrecognizable three-dimensional position is determined when the percentage shielded by the particulate deposit exceeds a threshold value and a recognizable three-dimensional position is determined when the percentage does not exceed the threshold value.

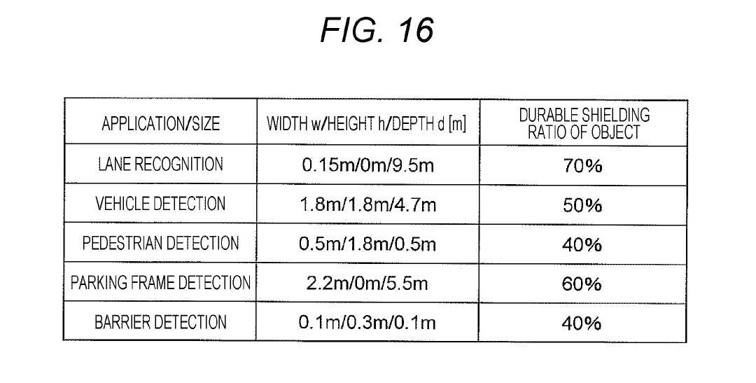

In this way, when the durable shielding ratio of the object in each application illustrated in FIG. 16 is calculated in the particulate deposit state, a position where a detection object detection rate decreases is estimated as a three-dimensional region based on the own vehicle. Here, when the object size is not defined as in the barrier detection, a certain size at a foot position is assumed and the visible state of the region may be determined instead.

FIG. 16 is a table showing a durable shielding ratio and a standard size of the recognition object of the application. Here, the durable shielding ratio indicates a state where the recognition object can be recognized when the size of the particulate deposit on the image is smaller than the size of the recognition object by a certain percentage. For example, when the particulate deposit is 50% or less of the size of the vehicle in the vehicle detection, the vehicle can be recognized. Further, when the particulate deposit is 40% or less of the size of the pedestrian in the pedestrian detection, the vehicle can be recognized. In this way, when the sensing enabled range of the camera is estimated in the three-dimensional region on the image, the sensing enabled range changing in response to the lens state of the camera can be easily notified to the user.

<Sharpness Distance Calculation Unit 320>

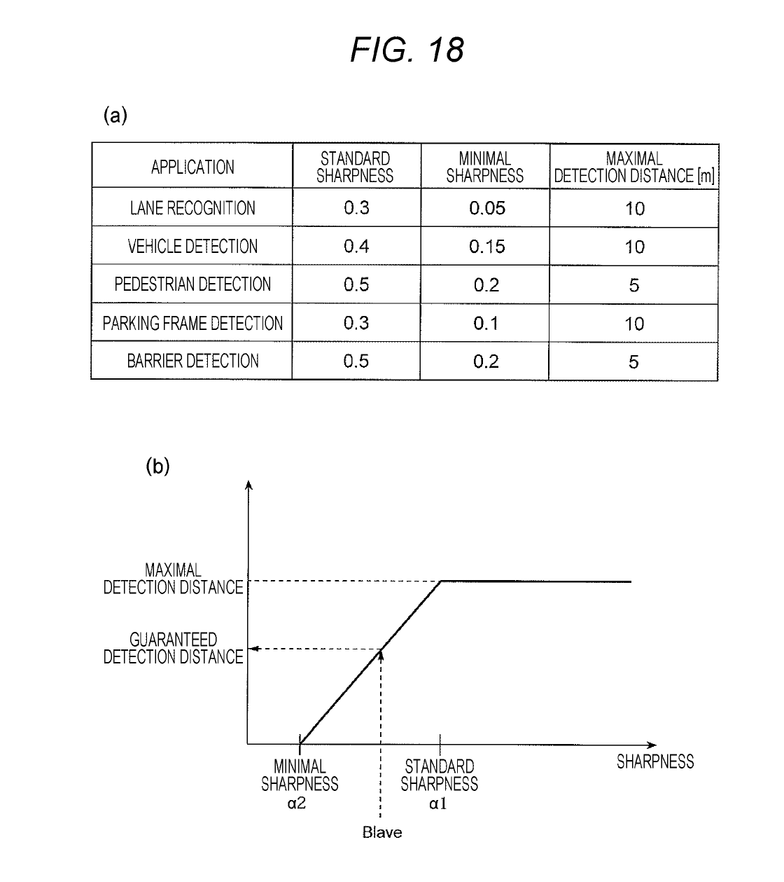

In the sharpness distance calculation unit 320 illustrated in FIG. 3, a guaranteed detection distance is calculated on the basis of the average value Blave of the sharpness obtained by the sharpness detector 220. First, standard sharpness α1 of the lens sharpness necessary for obtaining the edge strength used to recognize the recognition object to the maximal detection distance in each application is set. FIG. 18(a) is a diagram showing a relation between the maximal detection distance and the edge strength of each application. Then, when the sharpness is equal to or larger than the standard sharpness α1, each application can guarantee a sensing operation to the maximal detection distance. However, the guaranteed detection distance from the maximal detection distance becomes shorter as the sharpness becomes lower than the standard sharpness α1. The sharpness distance calculation unit 320 shortens the guaranteed detection distance as the sharpness decreases from the standard sharpness α1.

FIG. 18(b) is a graph showing a relation between a detection distance and sharpness. Here, when the sharpness Blave exists between the standard sharpness al and the minimal sharpness α2, the guaranteed detection distance of the application changes.

Regarding the setting of each application, as illustrated in the table of FIG. 18(a), when the maximal detection distance of each application exists and a range of the maximal detection distance is guaranteed, the standard sharpness α1 or more set for each application needs to be indicated by the average value Blave of the sharpness. As the average value Blave of the sharpness decreases from the standard sharpness α1, the guaranteed detection distance decreases. When the sharpness reaches the minimal sharpness α2 of the target application, the detection is not available.

For example, when the application is for the vehicle detection, the maximal detection distance becomes 10 m when the standard sharpness is 0.4 and the minimal detection distance becomes 0 m when the minimal sharpness is 0.15. Then, when the application is for the pedestrian detection, the maximal detection distance becomes 5 m when the standard sharpness is 0.5 and the minimal detection distance becomes 0 m when the minimal sharpness is 0.2.

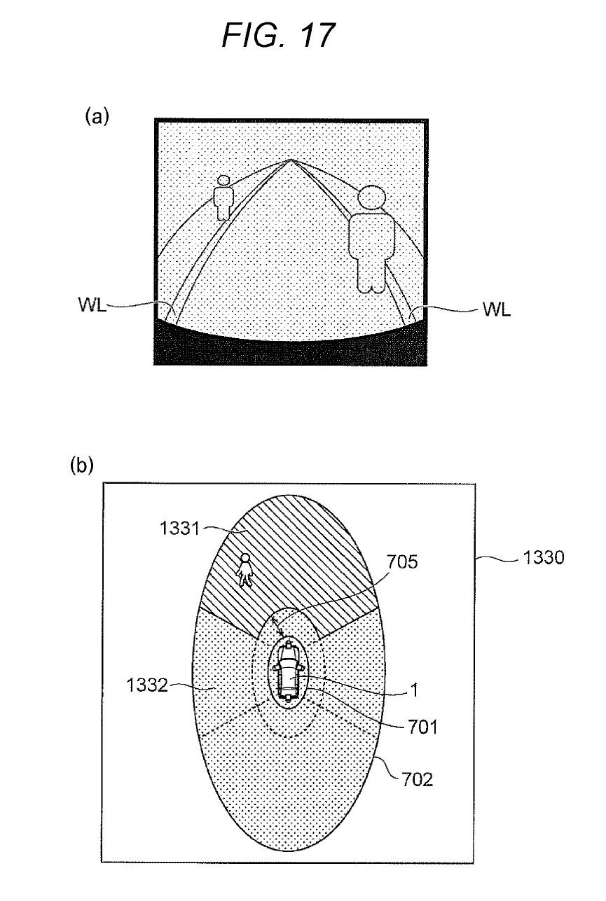

FIGS. 17(a) and 17(b) are diagrams showing a method of determining the sensing enabled range by the sensing range determination unit 300 in response to the sharpness. FIG. 17(a) shows an example in which the low sharpness state is displayed on the in-vehicle monitor and FIG. 17(b) shows an example in which the sensing disabled range 1331 incapable of recognizing (sensing) the pedestrian and the sensing enabled range 1332 capable of recognizing (sensing) the pedestrian are displayed on the display unit 1330 such as an in-vehicle monitor.

For example, when the sharpness is low due to cloudness as illustrated in FIG. 17(a), there is a high possibility that a far position is not visible. For this reason, as illustrated in FIG. 17(b) it is defined that a position farther than the predetermined distance 705 in the image captured by the in-vehicle camera 101 installed at the front part of the vehicle cannot used. The predetermined distance 705 is set such that a position moves close to the vehicle 1 as the sharpness becomes closer to the minimal sharpness and a position moves away from the vehicle 1 as the sharpness becomes closer to the standard sharpness.

<Water Droplet Distance Calculation Unit 330>

In the water droplet distance calculation unit 330 illustrated in FIG. 3, the sensing enabled range for each application is calculated on the basis of the result of the water droplet detector 230. A region within a process region of each application and having a score SB (x, y) exceeding the threshold value ThrB is calculated on the basis of the threshold value ThrB and the score SB (x, y) obtained as a result of the water droplet detection. Since this is obtained as a numerical value indicating the amount of the water droplet within the process region of each application, the water droplet occupying ratio is obtained for each application (each recognition application) in such a manner that an area of a water droplet adhering region (an area of a water droplet region corresponding to a region in which the water droplet adheres) within the process region of the application is divided by an area of the process region.

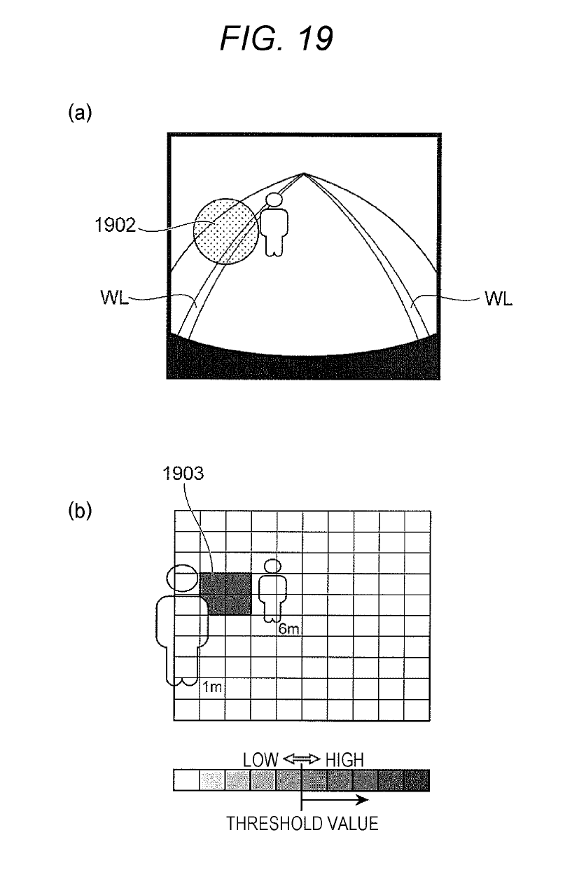

By using the water droplet occupying ratio, the maximal detection distance is determined. As illustrated in FIG. 19(a), there is a high possibility that the lens state promptly changes in the case of a water droplet 1902. For example, the lens state may change due to the water droplet of falling rain or from the road or the water droplet amount may be reduced due to the opposite traveling wind or the heat generated during the activation of the camera. Likewise, there is a high possibility that the lens state may change at all times. For this reason, it is possible to prevent a determination that the position 1903 is in a region which is out of a viewing angle or cannot be detected due to the position of the current water droplet. In the lens state involving with the current water droplet adhering amount, a far position or a small object position cannot be correctly determined. Accordingly, an operation depending on the lens state is guaranteed in such a manner that the detection distance is set to be short.

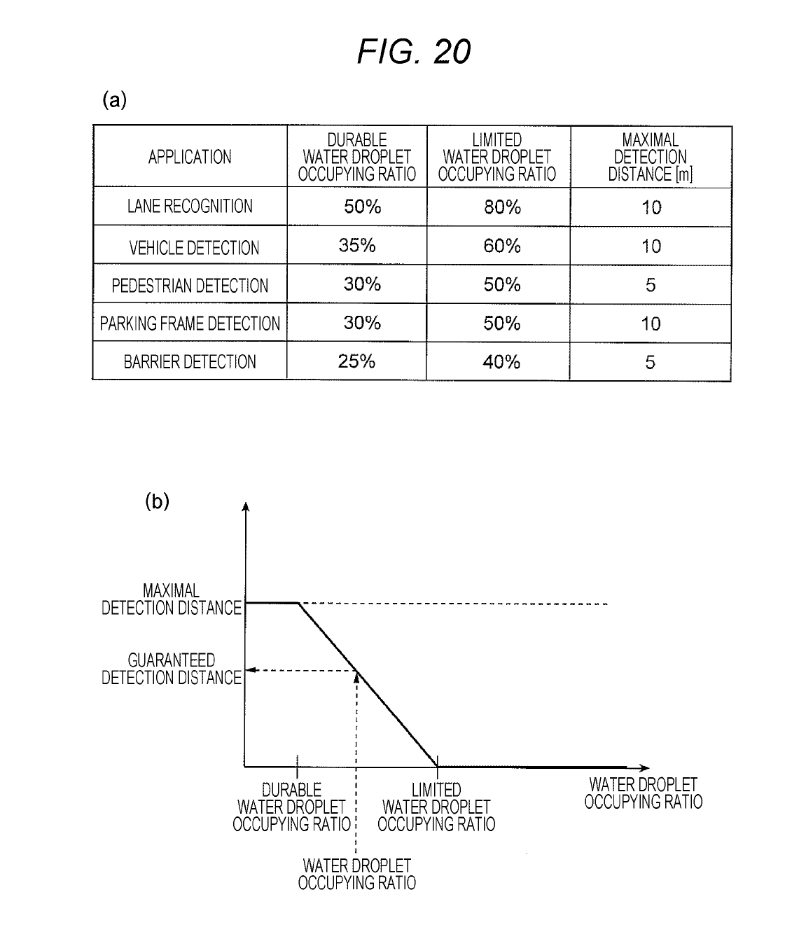

Since the process region is different for each application, the water droplet distance calculation unit 330 calculates the Guaranteed detection distance from the water droplet occupying ratio obtained in consideration of the process region. Further, the water droplet occupying ratio capable of guaranteeing the maximal detection distance of the application from the value of the water droplet occupying ratio is set as the durable water droplet occupying ratio illustrated in FIG. 20(a). Further, the water droplet occupying ratio incapable of guaranteeing the detection and the operation of the application is set as the limited water droplet occupying ratio. The limited water droplet occupying ratio state indicates a state where the guaranteed detection distance is 0 m. Here, the guaranteed detection distance from the durable water droplet occupying ratio to the limited water droplet occupying ratio decreases linearly as illustrated in FIG. 20(b).

The image of the background is not easily visible when the water droplet adheres to the lens. Thus, the image may be erroneously detected or may not be detected for an image recognition logic as the water droplet adhering amount on the lens increases. For this reason, since the water droplet adhering amount within the range of the image process for recognizing the recognition object among the water droplets adhering to the lens is obtained, the water droplet adhering amount is used while being converted to a degree causing an erroneous detection or a non-detection in each application (water droplet durability). For example, when the water droplet occupying ratio within the process region of the lane recognition is high, a large water droplet amount exists in the region where a lane exists on the image. Accordingly, there is a possibility that the lane cannot be appropriately recognized. Here, as for the detection of a far position which can be easily influenced by the distortion of the water droplet, the guaranteed target is not ensured at a level in which the water droplet occupying ratio is slightly raised and the guaranteed target is not ensured even in a near distance in response to an increase in water droplet occupying ratio.

For example, even when the application in execution is the vehicle detection, the maximal detection distance of 10 m can be guaranteed until the water droplet occupying ratio becomes 35% or less of the durable water droplet occupying ratio 35%. Here, when the water droplet occupying ratio becomes larger than 60% of the limited water droplet occupying ratio, the minimal detection distance becomes 0 m. Then, when the application is the pedestrian detection, the maximal detection distance of 5 m can be guaranteed when the water droplet occupying ratio becomes 30% of the durable water droplet occupying ratio. Then, the minimal detection distance becomes 0 m when the water droplet occupying ratio becomes larger than 50% of the limited water droplet occupying ratio.

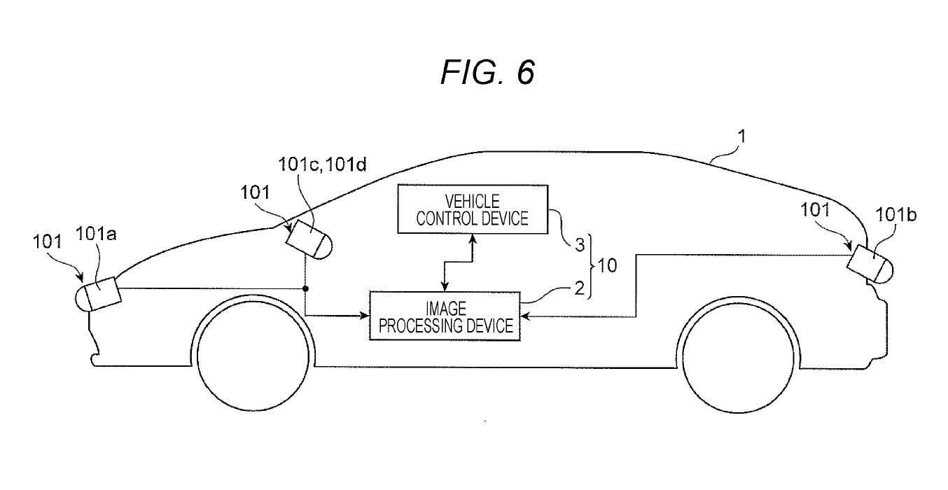

FIG. 4 is a block diagram showing an internal function of the application execution unit 400.

The application execution unit 400 includes, for example, a lane recognition unit 410, a vehicle detector 420, a pedestrian detector 430, a parking frame detector 440, and a barrier detector 450 to be executed on the basis of a predetermined condition.

The application execution unit 400 executes various applications used for recognizing the image in order to improve the preventive safety or the convenience by using the image captured by the in-vehicle camera 101 as an input.

The lane recognition unit 410 executes, for example, the lane recognition used to warn or prevent a vehicle lane departure, to conduct a vehicle lane keep assist, and to conduct a deceleration before a curve. In the lane recognition unit 410, a feature amount of the white line WL is extracted from the image and the linear property or the curved property of the feature amount is evaluated in order to determine whether the own vehicle exists at a certain horizontal position within the vehicle lane or to estimate a yaw angle representing an inclination with respect to the vehicle lane and a curvature of a travel vehicle lane. Then, when there is a possibility that the own vehicle may depart from the vehicle lane in response to the vehicle horizontal position, the yaw angle, or the curvature, an alarm for warning the risk to the driver is generated. Alternatively, when there is a possibility that the vehicle lane departure may occur, a control of returning the own vehicle to the own vehicle lane in order to prevent the departure is executed. Here, when the vehicle is controlled, there is a need to stabilize the vehicle lane recognition performance and to highly accurately obtain the horizontal position and the yaw angle. Further, when the vehicle lane to a far position can be extracted with high accuracy, an assist may be executed which has high curvature estimation accuracy, can be used for a control on a curve, and can support a smooth curve travel operation.

The vehicle detector 420 extracts a square shape on the image of the rear face of the preceding vehicle as a feature amount in order to extract a vehicle candidate. It is determined that the candidate is not a stationary object by checking whether the candidate moves on the screen at the own vehicle speed differently from the background. Further, the candidate may be narrowed by the pattern matching for a candidate region. In this way, when the vehicle candidate is narrowed to estimate the relative position with respect to the own vehicle, it is determined whether the own vehicle may contact or collide with the vehicle candidate. Accordingly, it is determined whether the vehicle candidate becomes a warning target or a control target. In the application used to follow the preceding vehicle, an automatic following operation with respect to the preceding vehicle is executed by the control of the own vehicle speed in response to the relative distance of the preceding vehicle.

The pedestrian detector 430 narrows a pedestrian candidate by extracting a feature amount based on a head shape or a leg shape of a pedestrian. Further, a moving pedestrian is detected on the basis of a determination reference indicating a state whether the pedestrian candidate moves in a collision direction by the use of a comparison of a movement of a background of a stationary object moving along with the movement of the own vehicle. By the pattern matching, the stationary pedestrian may be also used as a target. In this way, when the pedestrian is detected, it is possible to execute a warning or control process depending on whether the pedestrian jumps into the own vehicle lane. Further, it is possible to obtain an application which is very helpful for a low-speed region such as a parking place or an intersection instead of a road travel state.

The parking frame detector 440 extracts a white line feature amount similarly to the white line recognition when the vehicle travels at a low speed, for example, 20 km or less. Next, all lines having different inclination degrees and existing on the screen are extracted by Hough transformation. Further, a parking frame is checked to assist the driver's parking operation instead of searching for a simple white line. It is checked whether the horizontal width of the parking frame is a width in which the vehicle 1 needs to be stopped or the vehicle 1 can be parked in a parking region by detecting a bumper block or a white line at the front or rear side of the vehicle 1. When the parking frame is visible to a far position in a wide Parking lot, the user can select a suitable parking frame from a plurality of parking frame candidates. However, only when a near parking frame is visible, the user needs to approach a near parking space in order to recognize the parking frame. Further, since the recognition is basically used for the parking control of the vehicle 1, the user is informed of the non-control state when the recognition is not stable.

The barrier detector 450 extracts a feature point on an image. The feature point having an original feature on an image including an angle for an object may be considered as a feature point having the same feature when a change on the image is small even at the next frame. By the use of the feature points between two frames or multiple frames, a three-dimensional restoration is executed. At this time, a barrier which may collide with the own vehicle is detected.

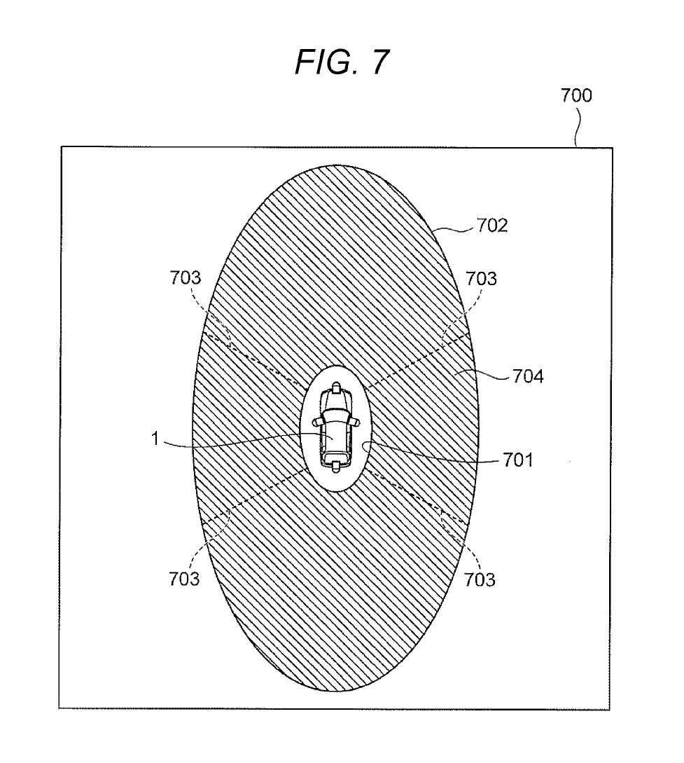

FIG. 5 is a block diagram showing an internal function of the notification control unit 500.

The notification control unit 500 includes, for example, a warning unit 510, a control unit 520, a display unit 530, a stain removing unit 540, an LED display unit 550, and the like.

The notification control unit 500 is an interface unit that receives the determination result of the sensing range determination unit 300 and transmits the information to the user. For example, in a normal state where a sensing disabled range does not exist in a sensing range necessary for the application and the entire sensing range becomes a sensing enabled range, a green LED is turned on. Then, a green LED is turned on and off in a suppression mode. Then, in a system give-up state having a temporary possibility of an early return due to a rain or the like, an orange LED is turned on. Meanwhile, in a system give-up state having a low possibility of a return unless the lens is wiped by the user due to a durable stain such as mud or cloudness on the lens, a red LED is turned on. In this way, a system configuration is obtained in order to warn a current preventive safety application operation state and an abnormal state caused by the stain of the lens of a current system to the user. In addition, the system give-up state indicates a state where an application for recognizing a recognition object is stopped for the preventive safety when it is determined that an image suitable for an image recognition cannot be captured due to the particulate deposit on the lens surface. Further, the system give-up state indicates a state where a CAN output is stopped even when the recognition is not stopped or a warning corresponding to a final output or a recognition object recognition result is not transmitted to the user during a vehicle control or a display on a screen or even when a CAN output is generated. In the system give-up state, the give-up state of the recognition system may be notified to the user through a display or a voice while the recognition object recognition result is not notified to the user.

In addition, when the preventive safety application is temporarily changed to the system give-up state, this transition state may be notified to the user through a display for warning the stop of the preventive safety application or a voice for warning the stop of the preventive safety application while not disturbing the driving operation of the driver. In this way, a function of notifying the transition of the application of the lane recognition or the vehicle detection to the stop state to the user may be provided. Further, a return state may be notified to the user through a display or a voice. Further, in a situation in which visibility is not improved by a road structure tracking unit although the lens state is improved when it is determined that a durable stain adheres to the lens, the lens may be improved after an orange display is selected as a failure display in a durable give-up state. In fact, there is also a possibility influenced by the light source or the background. Further, when it is determined that a durable stain other than a water droplet adheres to the lens so that a particularly red LED is turned on, an instruction may be Given to the user so that the lens is wiped by the user when the vehicle is stopped or before the vehicle starts to travel.

Since the user is informed of the application operation state based on the lens state diagnosed by the lens state diagnosis unit 200 and the sensing enabled range determined by the sensing range determination unit 300, it is possible to prevent a problem in which a preventive safety function is stopped without a notice to the user.

When the user is informed of the current system state so that the user does not doubt the failure of the system and the vehicle lane departure is warned to the user during the operation of the vehicle lane recognition, an improvement treatment method using a lens wiping and clearing hardware is notified to the user.

When a situation is not easily improved unless the user removes the stain of the lens surface in the system give-up state caused by the stain of the lens, this state is notified to the user. Accordingly, a further improvement request is notified to the user and a non-operation state of a current application is notified to the user.

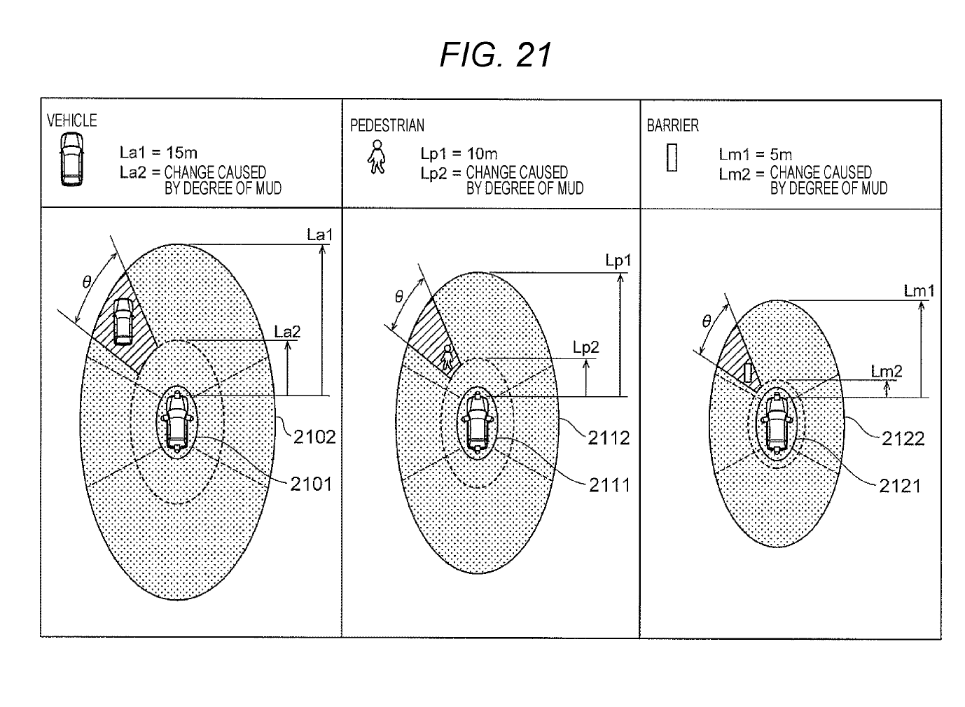

FIG. 21 is a diagram comparing the sensing enabled range in response to the recognition object.

When the particulate deposit adhering to the front in-vehicle camera 101 has the same size and position and the recognition object of the application corresponds to three kinds of recognition objects, that is, a vehicle, a pedestrian, and a barrier, the size of the recognition object is different in each application and thus the sensing range is also different. For example, when the recognition object is the vehicle, a forward vehicle length La2 of a minimum sensing range 2101 and a forward vehicle length La1 of a maximum sensing range 2102 are longer than a forward vehicle length Lp2 of a minimum sensing range 2111 and a forward vehicle length Lp1 of a maximum sensing range 2112 of the pedestrian and a forward vehicle length Lm2 of a minimum sensing range 2121 and a forward vehicle length Lm1 of a maximum sensing range 2122 of the barrier are smaller than the forward vehicle length Lp2 of the minimum sensing range 2111 and the forward vehicle length Lp1 of the maximum sensing range 2112 of the pedestrian. Meanwhile, an angle θ in which a background is hidden by the particulate deposit is substantially the same among the applications, but is corrected in response to the size of the recognition object.

According to the surrounding environment recognition device 10 of the invention, it is possible to notify the sensing enabled range set in response to the stain of the lens of the in-vehicle camera 101 to the user and to allow the user to check a range capable of recognizing the recognition object of the application. Thus, it is possible to allow the user to drive the vehicle while further keeping an eye on the surrounding environment by preventing a careless attention on the surrounding environment due to the overestimation of the application.

While the embodiment of the invention has been described, the invention is not limited to the above-described embodiment and various modifications in design can be made without departing from the spirit of the invention of claims. For example, the above-described embodiment has been carefully explained for the easy comprehension of the invention and all configurations may not be essentially provided. Further, a part of a configuration of a certain embodiment may be replaced as a configuration of the other embodiment and a configuration of the other embodiment may be added to a configuration of a certain embodiment. Furthermore, the other configurations may be added to, deleted from, or replaced by a part of a configuration of each embodiment.

### REFERENCE SIGNS LIST

10 surrounding environment recognition device
100 image capturing unit
200 lens state diagnosis unit
210 particulate deposit detector
220 sharpness detector
230 water droplet detector
300 sensing range determination unit
310 particulate deposit distance calculation unit
320 sharpness distance calculation unit
330 water droplet adhering distance calculation unit
400 application execution unit
410 lane recognition unit
420 vehicle detector
430 pedestrian detector
440 parking frame detector
450 barrier detector
500 notification control unit
510 warning unit
520 control unit
530 display unit
540 stain removing unit
550 LED display unit

1. A surrounding environment recognition device which recognizes a surrounding environment based on such an image that an outside environment is imaged with a camera, comprising:
an image acquisition unit that acquires the image;
an application execution unit that executes an application for recognizing an object to be recognized;
a lens state diagnosis unit that diagnoses a lens state of the camera based on the image;
a sensing range determination unit that determines a sensing-enabled range allowing the sensing of the object to be recognized and a sensing-disabled range not enabling the sensing of the object to be recognized, with the lens state diagnosed by the lens state diagnosis unit in the case where the application is executed, and
a notification control unit that notifies at least one of the sensing-enabled range and the sensing-disabled range of the sensing range determination unit,
wherein the sensing-disabled range is a range, among a sensing range allowing the sensing of the object to be recognized in a state that a lens of the camera has no stain in the case where the application is executed, that is defined by a predetermined depth distance and a predetermined viewing angle from the camera.

2. The surrounding environment recognition device according to claim 1, further comprising:
a plurality of applications,
wherein the sensing range determination unit determines the sensing enabled range in response to the recognition object recognized by each application.

3. The surrounding environment recognition device according to claim 2,
wherein the lens state diagnosis unit includes at least one of a particulate deposit detector that detects a particulate deposit adhering to the lens, a sharpness detector that detects sharpness of the lens, and a water droplet detector that detects a water droplet adhering to the lens, and
wherein the lens state is diagnosed on the basis of a detection result.

4. The surrounding environment recognition device according to claim 3,
wherein the attached material detection unit calculates such an attached material area that the attached material occupies in the image, and
the sensing range determination unit calculates, through the use of a standard size of an object to be recognized of the application that has been defined in advance, such a percentage that the attached material area shields the standard size object to be recognized, and converts into the sensing-enabled range allowing to detect the object to be recognized based on a durable shield factor that has been set up in advance.

5. The surrounding environment recognition device according to claim 3,
wherein the definition detection unit detects each edge of a plurality of areas including a horizontal line imaged in the image, and sets up a definition based on an edge strength of each of the edges, and
the sensing range determination unit shortens the sensing-enabled range allowing to detect the object to be recognized in accordance with lowering of the definition.

6. The surrounding environment recognition device according to claim 3,
wherein the droplet detection unit calculates a droplet occupying in each processing area by a recognition application, through the use of a droplet area detected, and changes the sensing-enabled region by a recognition application in accordance with the droplet occupancy.
